(19) United States
(12) Patent Application Publication
(10) Pub. No.: US 2022/0178107 A1
(43) Pub. Date: Jun. 9, 2022

(54) SYSTEM AND METHOD FOR CONTROLLING WORK MACHINE

(71) Applicant: KOMATSU LTD., Tokyo (JP)

(72) Inventor: Yukihisa TAKAOKA, Tokyo (JP)

(21) Appl. No.: 17/439,882

(22) PCT Filed: May 20, 2020
(86) PCT No.: PCT/JP2020/019863

§ 371 Date: Sep. 16, 2021

(30) Foreign Application Priority Data
Jun. 3, 2019 (JP) 2019-104001

(51) Int. Cl. E02F 3/84; E02F 9/26; E02F 9/20

(52) U.S. Cl. CPC E02F 3/841; E02F 9/262; E02F 9/2054; E02F 9/205; E02F 9/265

(57) ABSTRACT

One or more processors control a first work machine to work according to a first work lane. The one or more processors control a second work machine to work according to a second work lane. The one or more processors determine whether at least a part of the second work machine is located in a first work area. When at least a part of the second work machine is located in the first work area, the one or more processors control the first work machine to perform an interference avoidance operation with respect to the second work machine.

### CROSS-REFERENCE TO RELATED APPLICATIONS

This application is a U.S. National stage application of International Application No. PCT/JP2020/019863, filed on May 20, 2020. This U.S. National stage application claims priority under 35 U.S.C. § 119(a) to Japanese Patent Application No. 2019-104001, filed in Japan on Jun. 3, 2019, the entire contents of which are hereby incorporated herein by reference.

### BACKGROUND

Filed of the Invention

### TECHNICAL FIELD

The present disclosure relates to a system and a method for controlling a work machine.

### BACKGROUND INFORMATION

At a work site, a plurality of work machines may work together. For example, in U.S. Pat. No. 9,014,922, a plurality of bulldozers cooperate to excavate in the same work site. The bulldozers excavate according to work lanes extending in a predetermined working direction.

### SUMMARY

The work site is divided into a plurality of work areas, and the work machine is automatically operated in each work area, so that the efficiency of the system can be improved. However, in that case, it is required to avoid interference with another work machine working in the adjacent work area.

An object of the present disclosure is to prevent a plurality of work machines from interfering with each other during automatic operation.

A system according to one aspect is a system for controlling a plurality of work machines including a first work machine and a second work machine. The system includes the first work machine, the second work machine, and one or more processors. The one or more processors allocate a first work area to the first work machine. The first work area includes a plurality of first work lanes. The plurality of first work lanes extend in a predetermined first working direction. The plurality of first work lanes are arranged in a direction intersecting the first working direction. The one or more processors acquire first position data indicative of a position of the first work machine. The one or more processors control the first work machine to work according to the first work lane. The one or more processors allocate a second work area to the second work machine. The second work area includes a plurality of second work lanes. The plurality of second work lanes extend in a predetermined second working direction. The plurality of second work lanes are arranged in a direction intersecting the second working direction. The one or more processors acquire second position data indicative of a position of the second work machine. The one or more processors control the second work machine to work according to the second work lane. The one or more processors determine whether at least a part of the second work machine is located in the first work area. The one or more processors control the first work machine to perform an interference avoidance operation with respect to the second work machine when at least a part of the second work machine is located in the first work area.

A method according to another aspect is a method performed by one or more processors for controlling a plurality of work machines including a first work machine and a second work machine. The method includes the following processing. A first process is to allocate a first work area to the first work machine. The first work area includes a plurality of first work lanes. The plurality of first work lanes extend in a predetermined first working direction. The plurality of first work lanes are arranged in a direction intersecting the first working direction. A second process is to acquire first position data indicative of a position of the first work machine. A third process is to control the first work machine to work according to the first work lane. A fourth process is to allocate a second work area to the second work machine. The second work area includes a plurality of second work lanes. The plurality of second work lanes extend in a predetermined second working direction. The plurality of second work lanes are arranged in a direction intersecting the second working direction. A fifth process is to acquire second position data indicative of a position of the second work machine. A sixth process is to control the second work machine to work according to the second work lane. A seventh process is to determine whether at least a part of the second work machine is located in the first work area. An eighth process is to control the first work machine to perform an interference avoidance operation with respect to the second work machine when at least a part of the second work machine is located in the first work area.

A system according to further another aspect is a system for controlling a plurality of work machines including a first work machine and a second work machine. The system includes the first work machine, the second work machine, and one or more processors. The one or more processors allocate a first work lane to the first work machine. The first work lane extends in a predetermined first working direction. The one or more processors acquire first position data indicative of a position of the first work machine. The one or more processors control the first work machine to work according to the first work lane. The one or more processors allocate a second work lane to the second work machine. The second work lane extends in a predetermined second working direction. The one or more processors acquire second position data indicative of a position of the second work machine. The one or more processors control the second work machine to work according to the second work lane. The one or more processors determine whether at least a part of the second work machine is located in the first work lane. The one or more processors control the first work machine to perform an interference avoidance operation with respect to the second work machine when at least a part of the second work machine is located in the first work lane.

According to the present disclosure, it is possible to prevent a plurality of work machines from interfering with each other during automatic operation.

### BRIEF DESCRIPTION OF THE DRAWINGS

FIG. 1 is a schematic diagram showing a control system for a work machine according to an embodiment.

FIG. 2 is a side view of the work machine.

FIG. 3 is a schematic diagram showing a structure of the work machine.

FIG. 4 is a flowchart showing a process of automatic control.

FIG. 5 is a side view showing an example of a current terrain.

FIG. 6 is a top view of a work site showing an example of work areas according to a first embodiment.

FIG. 7 is a diagram showing an example of positions of a first work machine and a second work machine according to the first embodiment.

FIG. 8 is a flowchart showing a process for an interference avoidance operation.

FIG. 9 is a diagram showing another example of the positions of the first work machine and the second work machine.

FIG. 10 is a top view of a work site showing an example of work areas according to a second embodiment.

FIG. 11 is a flowchart showing a process of the interference avoidance operation when a first work lane and a second work lane overlap each other.

FIG. 12 is a diagram showing an example of a first determination region and a second determination region.

FIG. 13 is a diagram showing another example of the first determination region and the second determination region.

FIG. 14 is a top view of a work site showing an example of work areas according to a third embodiment.

FIG. 15 is a diagram showing an example of the positions of the first work machine and the second work machine.

FIG. 16 is a diagram showing another example of the positions of the first work machine and the second work machine.

### DESCRIPTION OF EXEMPLARY EMBODIMENTS

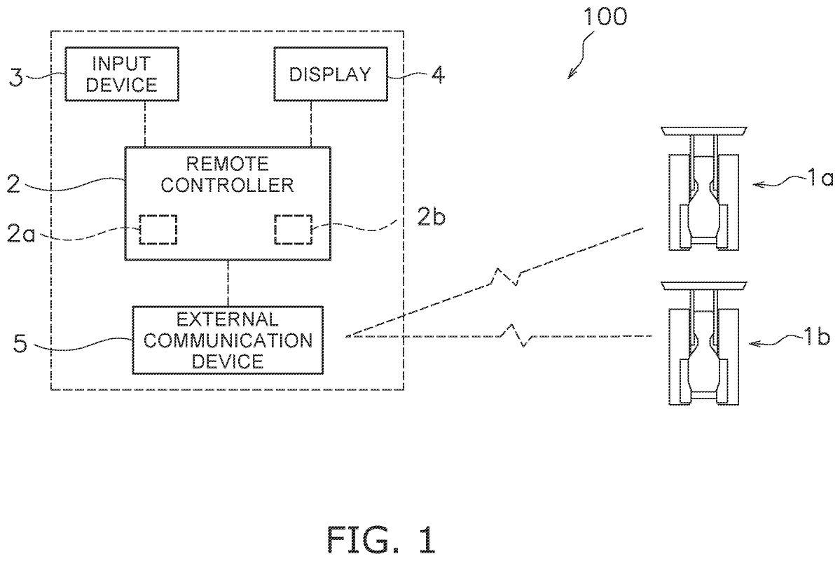

Hereinafter, a control system for a work machine according to an embodiment will be described with reference to the drawings. FIG. 1 is a schematic view showing a control system 100 for a work machine according to an embodiment. As illustrated in FIG. 1, the control system 100 includes a plurality of work machines 1a and 1b, a remote controller 2, an input device 3, a display 4, and an external communication device 5. The control system 100 controls the work machines 1a and 1b arranged at a work site such as a mine. The plurality of work machines 1a and 1b include a first work machine 1a and a second work machine 1b. The work machines 1a and 1b according to the present embodiment are bulldozers.

The remote controller 2, the input device 3, the display 4, and the external communication device 5 are arranged outside the work machines 1a and 1b. The remote controller 2, the input device 3, the display 4, and the external communication device 5 may be arranged in, for example, an external management center of the work machines 1a and 1b. The remote controller 2 remotely controls the work machines 1a and 1b. The number of work machines remotely controlled by the remote controller 2 is not limited to two, and may be more than two.

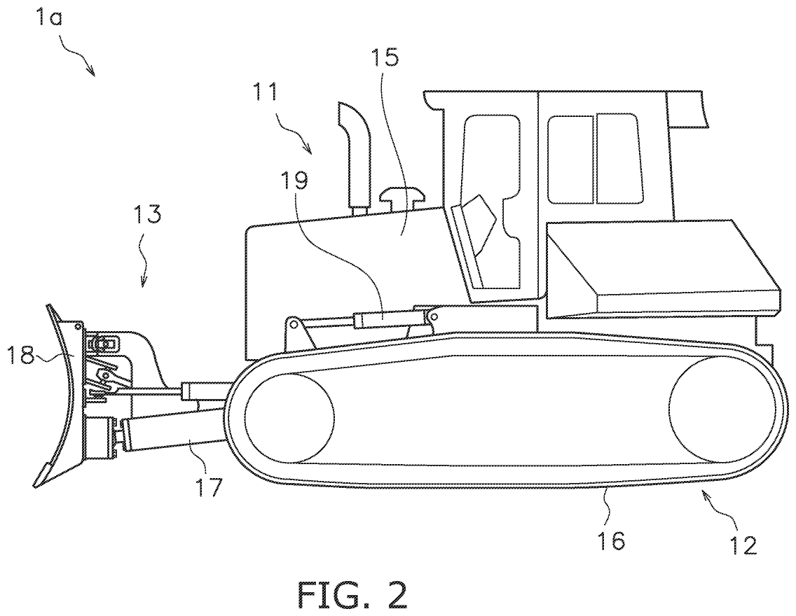

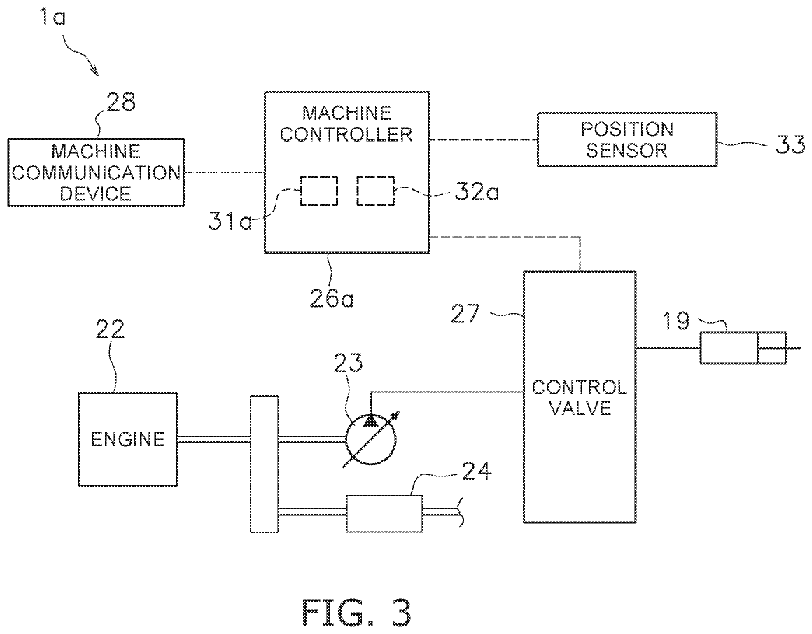

FIG. 2 is a side view of the first work machine 1a. FIG. 3 is a block diagram showing a configuration of the first work machine 1a. Hereinafter, the first work machine 1a will be described, but the configuration of the second work machine 1b is the same as that of the first work machine 1a. As illustrated in FIG. 2, the first work machine 1a includes a vehicle body 11, a traveling device 12, and a work implement 13. The vehicle body 11 includes an engine compartment 15. The traveling device 12 is attached to the vehicle body 11. The traveling device 12 includes left and right crawler tracks 16. In FIG. 2, only the left crawler track 16 is illustrated. The first work machine 1a travels by rotating the crawler tracks 16.

The work implement 13 is attached to the vehicle body 11. The work implement 13 includes a lift frame 17, a dosing blade 18, and a lift cylinder 19. The lift frame 17 is attached to the vehicle body 11 so as to be movable up and down. The lift frame 17 supports the dosing blade 18. The dosing blade 18 moves up and down with the operation of the lift frame 17. The lift frame 17 may be attached to the traveling device 12. The lift cylinder 19 is connected to the vehicle body 11 and the lift frame 17. As the lift cylinder 19 expands and contracts, the lift frame 17 moves up and down.

As illustrated in FIG. 3, the first work machine 1a includes an engine 22, a hydraulic pump 23, a power transmission device 24, and a control valve 27. The hydraulic pump 23 is driven by the engine 22 to discharge hydraulic fluid. The hydraulic fluid discharged from the hydraulic pump 23 is supplied to the lift cylinder 19. Although one hydraulic pump 23 is illustrated in FIG. 3, a plurality of hydraulic pumps may be provided.

The power transmission device 24 transmits the driving force of the engine 22 to the traveling device 12. The power transmission device 24 may be, for example, an HST (Hydro Static Transmission). Alternatively, the power transmission device 24 may be a transmission including a torque converter or a plurality of speed gears. Alternatively, the power transmission device 24 may be another type of transmission.

The control valve 27 is arranged between the hydraulic pump 23 and the hydraulic actuator such as the lift cylinder 19. The control valve 27 controls the flow rate of the hydraulic fluid supplied from the hydraulic pump 23 to the lift cylinder 19. The control valve 27 may be a pressure proportional control valve. Alternatively, the control valve 27 may be an electromagnetic proportional control valve.

The first work machine 1a includes a machine controller 26a and a machine communication device 28. The machine controller 26a runs the first work machine 1a by controlling the traveling device 12 or the power transmission device 24. The machine controller 26a moves the dosing blade 18 up and down by controlling the control valve 27.

The machine controller 26a is programmed to control the first work machine 1a based on the acquired data. The machine controller 26a includes a processor 31a and a storage device 32a. The processor 31a is, for example, a CPU (central processing unit). Alternatively, the processor 31a may be a processor different from the CPU. The processor 31a executes a process for controlling the first work machine 1a according to the program.

The storage device 32a includes a non-volatile memory, such as ROM, and a volatile memory, such as RAM. The storage device 32a may include an auxiliary storage device, such as a hard disk or an SSD (Solid State Drive). The storage device 32a is an example of a non-transitory computer-readable recording medium. The storage device 32a stores computer commands and data for controlling the first work machine 1a.

The machine communication device 28 wirelessly communicates with the external communication device 5. For example, the machine communication device 28 communicates with the external communication device 5 by a wireless LAN, such as Wi-Fi (registered trademark), mobile communication, such as 3G, 4G, or 5G, or another type of wireless communication system.

The first work machine 1a includes a position sensor 33. The position sensor 33 may include a GNSS (Global Navigation Satellite System) receiver, such as GPS (Global Positioning System). Alternatively, the position sensor 33 may include a receiver for another positioning system. The position sensor 33 may include a motion sensor, such as an IMU (Inertial Measurement Unit), a distance measurement sensor, such as a Lidar device, or an image sensor, such as a stereo camera. The position sensor 33 outputs position data to the machine controller 26a. The position data indicates a position of the first work machine 1a.

The external communication device 5 illustrated in FIG. 1 wirelessly communicates with the machine communication device 28. The external communication device 5 transmits a command signal from the remote controller 2 to the machine communication device 28. The machine controller 26a receives the command signal via the machine communication device 28. The external communication device 5 receives the position data of the first work machine 1a via the machine communication device 28.

The input device 3 is a device that is operable by an operator. The input device 3 receives an input command from the operator and outputs an operation signal corresponding to the input command to the remote controller 2. The input device 3 outputs the operation signal corresponding to the operation by the operator. The input device 3 outputs the operation signal to the remote controller 2. The input device 3 may include a pointing device such as a mouse or a trackball. The input device 3 may include a keyboard.

The display 4 includes a monitor such as a CRT, an LCD, or an OELD. The display 4 receives an image signal from the remote controller 2. The display 4 displays an image corresponding to the image signal. The display 4 may be integrated with the input device 3. For example, the input device 3 and the display 4 may include a touch screen.

The remote controller 2 remotely controls the work machines 1a and 1b. The remote controller 2 receives the operation signal from the input device 3. The remote controller 2 outputs the image signal to the display 4. The remote controller 2 includes a processor 2a and a storage device 2b. The processor 2a is, for example, a CPU (Central Processing Unit). Alternatively, the processor 2a may be a processor different from the CPU. The processor 2a executes a process for controlling the work machines 1a and 1b according to the program. In the following description, the description regarding the process executed by the remote controller 2 may be interpreted as the process executed by the processor 2a.

The storage device 2b includes a non-volatile memory, such as ROM, and a volatile memory, such as RAM. The storage device 2b may include an auxiliary storage device, such as a hard disk or an SSD (Solid State Drive). The storage device 2b is an example of a non-transitory computer-readable recording medium. The storage device 2b stores computer commands and data for controlling the work machines 1a and 1b.

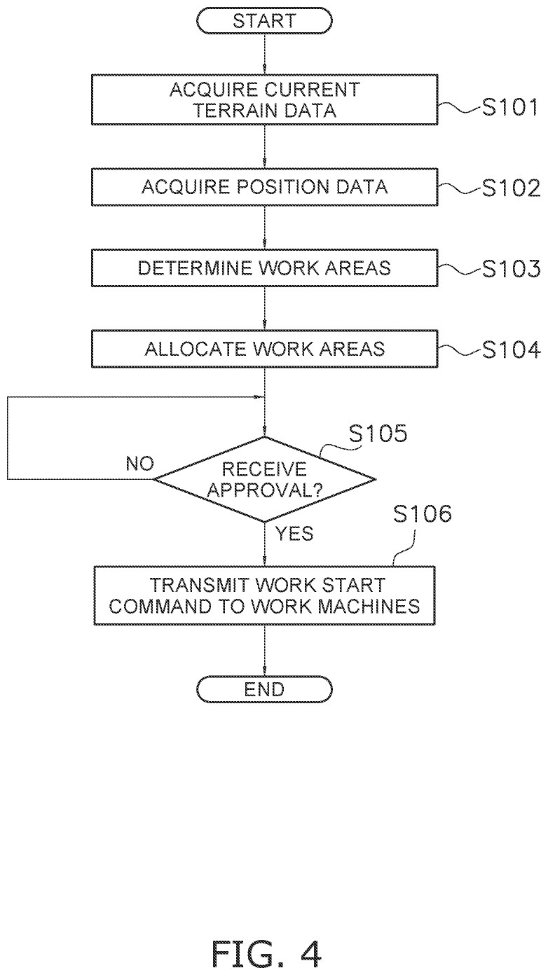

Next, the automatic operation of the work machines 1a and 1b executed by the control system 100 will be described. FIG. 4 is a flowchart showing the processing performed by the remote controller 2.

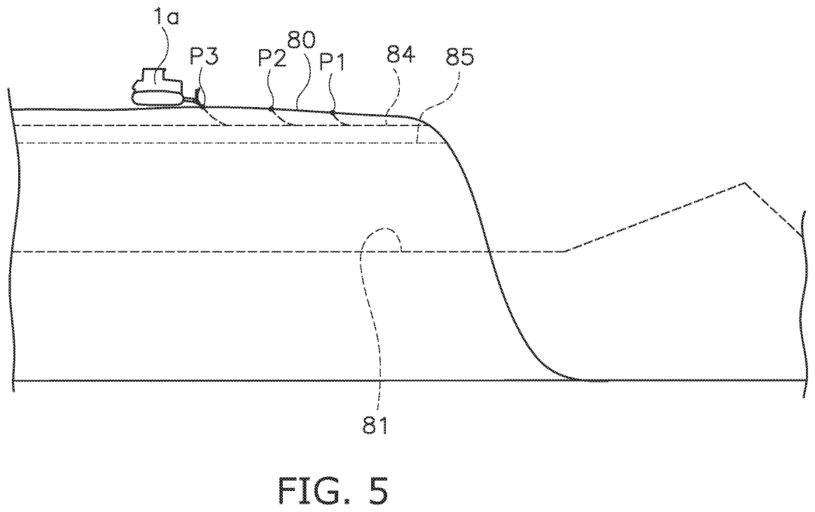

As illustrated in FIG. 4, in step S101, the remote controller 2 acquires current terrain data. The current terrain data indicates the current terrain of the work site. FIG. 5 is a side view showing an example of the current terrain 80. The current terrain data includes coordinates and altitudes of a plurality of points on the current terrain 80. The work machines 1a and 1b excavate the current terrain 80 by automatic operation so that the current terrain 80 has a shape along the final target terrain 81.

In step S102, the remote controller 2 acquires the position data. The position data includes the first position data of the first work machine 1a and the second position data of the second work machine 1b. The first position data indicates the position of the first work machine 1a. The second position data indicates the position of the second work machine 1b.

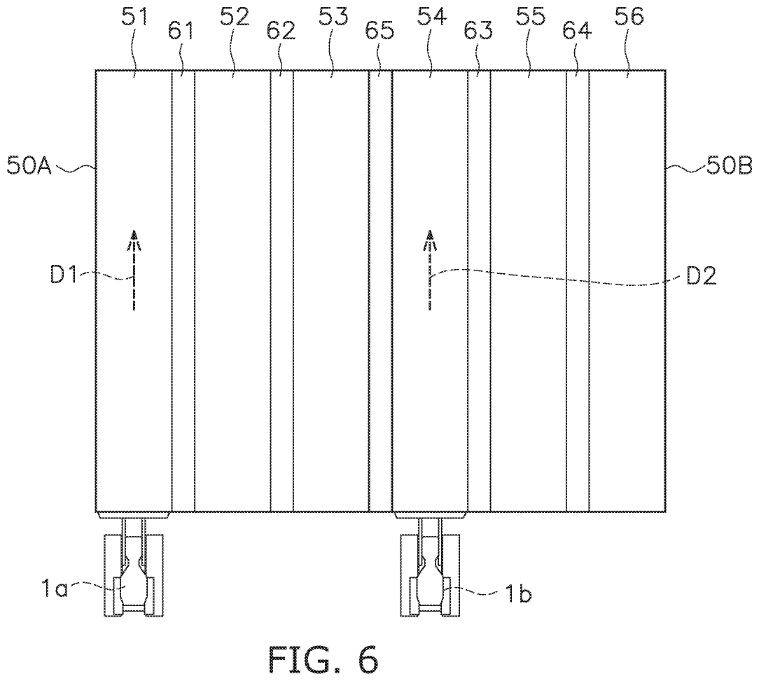

In step S103, the remote controller 2 determines a plurality of work areas 50A and 50B at the work site. FIG. 6 is a top view of the work site showing an example of the work areas 50A and 50B according to a first embodiment. The plurality of work areas 50A and 50B include a first work area 50A and a second work area 50B. The first work area 50A includes a plurality of first work lanes 51 to 53. The plurality of first work lanes 51 to 53 extend in a predetermined first working direction D1. The plurality of first work lanes 51 to 53 extend linearly. The first work lanes 51 to 53 are arranged in a lateral direction of the first work area 50A. The lateral direction of the first work area 50A is a direction intersecting the first working direction D1.

The second work area 50B includes a plurality of second work lanes 54 to 56. The plurality of second work lanes 54 to 56 extend in a predetermined second working direction D2. The plurality of second work lanes 54 to 56 extend linearly. The second work lanes 54 to 56 are arranged in a lateral direction of the second work area 50B. The lateral direction of the second work area 50B is a direction intersecting the second working direction D2. In the example illustrated in FIG. 6, the first working direction D1 and the second working direction D2 are in the same direction.

The remote controller 2 may determine the work areas 50A and 50B according to the operation of the input device 3 by the operator. Alternatively, the remote controller 2 may automatically determine the work areas 50A and 50B.

The first work area 50A includes areas 61 and 62 of the first excavation wall. The areas 61 and 62 of the first excavation wall are arranged between the plurality of first work lanes 51 to 53. The width of each of the areas 61 and 62 of the first excavation wall is smaller than the width of each of the first work lanes 51 to 53. The remote controller 2 may determine the width of each of the first work lanes 51 to 53 based on the width dimension of the dosing blade 18 of the first work machine 1a. The remote controller 2 may determine a value smaller than the width dimension of the dosing blade 18 of the first work machine 1a as the width of the areas 61 and 62 of the first excavation wall.

The second work area 50B includes areas 63 and 64 of the second excavation wall. The areas 63 and 64 of the second excavation wall are arranged between the plurality of second work lanes 54 to 56. The width of each of the areas 63 and 64 of the second excavation wall is smaller than the width of each of the second work lanes 54 to 56. The remote controller 2 may determine the width of each of the second work lanes 54 to 56 based on the width dimension of the dosing blade of the second work machine 1b. The remote controller 2 may determine a value smaller than the width dimension of the dosing blade of the second work machine 1b as the width of the areas 63 and 64 of the second excavation wall.

The arrangement of the work lanes 51 to 56 and the areas 61 to 64 of the excavation wall is not limited to that illustrated in FIG. 6, and may be changed. For example, the number of work lanes in each work area is not limited to three, and may be less than three or more than three. The number of excavation wall areas in each work area is not limited to two, and may be less than two or more than two. The number of work lanes in the first work area 50A and the number of work lanes in the second work area 50B are not limited to the same, but may be different. The number of work areas is not limited to two and may be more than two.

In step S104, the remote controller 2 allocates the work areas 50A and 50B to the work machines 1a and 1b. The operator allocates each of the plurality of work areas 50A and 50B to any of the work machines 1a and 1b by the input device 3. The remote controller 2 determines a work machine allocated to each of the plurality of work areas 50A and 50B based on the operation signal from the input device 3. Alternatively, the remote controller 2 may automatically determine the work machines allocated to each of the plurality of work areas 50A and 50B. In the example illustrated in FIG. 6, the remote controller 2 allocates the first work area 50A to the first work machine 1a and the second work area 50B to the second work machine 1b.

The remote controller 2 allocates the area 65 of the third excavation wall located between the first work area 50A and the second work area 50B to either the first work machine 1a or the second work machine 1b. The remote controller 2 may allocate the area 65 of the third excavation wall to either the first work machine 1a or the second work machine 1b according to the operation of the input device 3 by the operator. Alternatively, the remote controller 2 may automatically allocate the area 65 of the third excavation wall to either the first work machine 1a or the second work machine 1b. In the example illustrated in FIG. 6, the remote controller 2 allocates the area 65 of the third excavation wall to the second work machine 1b.

In step S105, the remote controller 2 determines whether an approval for starting work has been received. The operator can instruct the approval by the input device 3 for starting work by the work machines 1a and 1b. The remote controller 2 determines whether the approval has been received based on the operation signal from the input device 3. The remote controller 2 may determine whether the approval has been received individually for each of the work machines 1a and 1b.

In step S106, the remote controller 2 transmits a work start command to the work machines 1a and 1b. Thereby, the first work machine 1a is controlled to perform the work according to the arrangement of the allocated first work lanes 51 to 53. The remote controller 2 transmits data indicative of the positions of the first work lanes 51 to 53 to the first work machine 1a. The remote controller 2 transmits data indicative of the positions of the second work lane 54 to 56 to the second work machine 1b.

The first work machine 1a moves to the first work lane 51 to 53 allocated to the first work machine 1a, and automatically aligns the position and the orientation with respect to the first work lane 51 to 53. Then, the first work machine 1a excavates while moving along the first work lanes 51 to 53. When the excavation of the first work lanes 51 to 53 is completed, the excavation walls remain between the first work lanes 51 to 53. The first work machine 1a excavates the excavation walls while moving along the allocated areas 61 and 62 of the first excavation wall. The excavation order of the first work lanes 51 to 53 or the excavation order of the areas 61 and 62 of the first excavation wall may be determined by the remote controller 2. Alternatively, the excavation order of the first work lanes 51 to 53 or the excavation order of the areas 61 and 62 of the first excavation wall may be determined by the machine controller 26a of the first work machine 1a.

Similarly, the second work machine 1b moves to the second work lane 54 to 56 allocated to the second work machine 1b, and automatically aligns the position and orientation with respect to the second work lane 54 to 56. Then, the second work machine 1b excavates while moving along the second work lane 54 to 56. When the excavation of the second work lane 54 to 56 is completed, the excavation walls remain between the second work lanes 54 to 56. The second work machine 1b excavates the excavation walls while moving along the allocated areas 63 and 64 of the second excavation wall. The excavation order of the second work lanes 54 to 56 or the excavation order of the areas 63 and 64 of the second excavation wall may be determined by the remote controller 2. Alternatively, the excavation order of the second work lanes 54 to 56 or the excavation order of the areas 63 and 64 of the second excavation wall may be determined by the machine controller of the second work machine 1b.

For example, as illustrated in FIG. 5, the first work machine 1a moves the dosing blade 18 according to the target design terrain 84. The first work machine 1a starts excavation while moving forward from the first starting point P1 on the current terrain 80, and drops the excavated soil from the cliff. The first work machine 1a retreats to the second starting point P2. The first work machine 1a starts excavation while moving forward from the second starting point P2, and drops the excavated soil from the cliff. The first work machine 1a retreats to the third starting point P3. The first work machine 1a starts excavation while moving forward from the third starting point P3, and drops the excavated soil from the cliff.

By repeating such work, the first work machine 1a excavates the current terrain 80 in a shape along the target design terrain 84. The second work machine 1b also excavates in the same manner as the first work machine 1a. When the work machines 1a and 1b complete the excavation of the target design terrain 84, the work machines 1a and 1b excavate the next target design terrain 85 located below the target design terrain 84. The work machines 1a and 1b repeat the above work until they reach the final target terrain 81 or its vicinity.

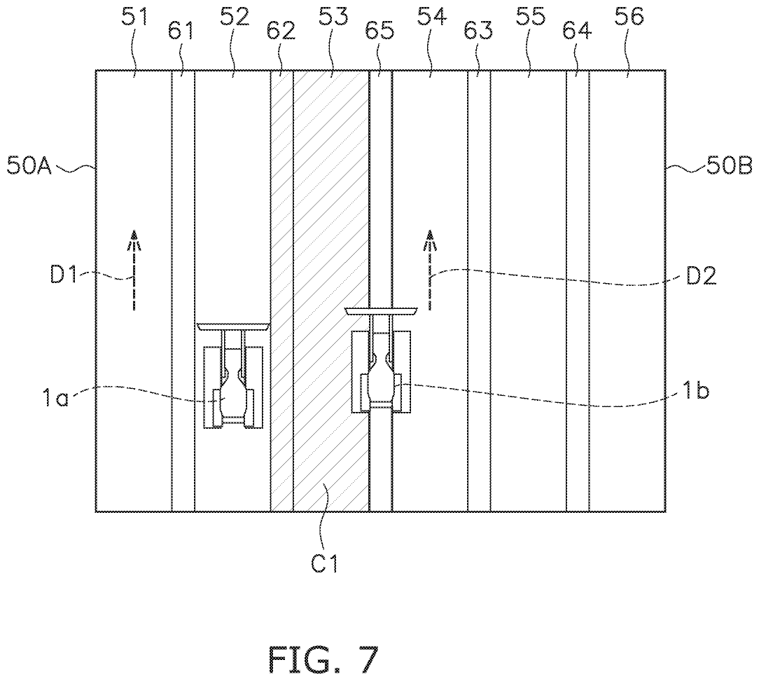

As described above, when the first work machine 1a and the second work machine 1b work in cooperation with each other, the first work machine 1a and the second work machine 1b may approach each other. For example, as illustrated in FIG. 7, when the second work machine 1b is working in the area 65 of the third excavation wall, at least a part of the second work machine 1b is located in the first work area 50A. In such a case, the first work machine 1a controls the first work machine 1a to perform an interference avoidance operation with respect to the second work machine 1b. Hereinafter, the control for the interference avoidance operation will be described.

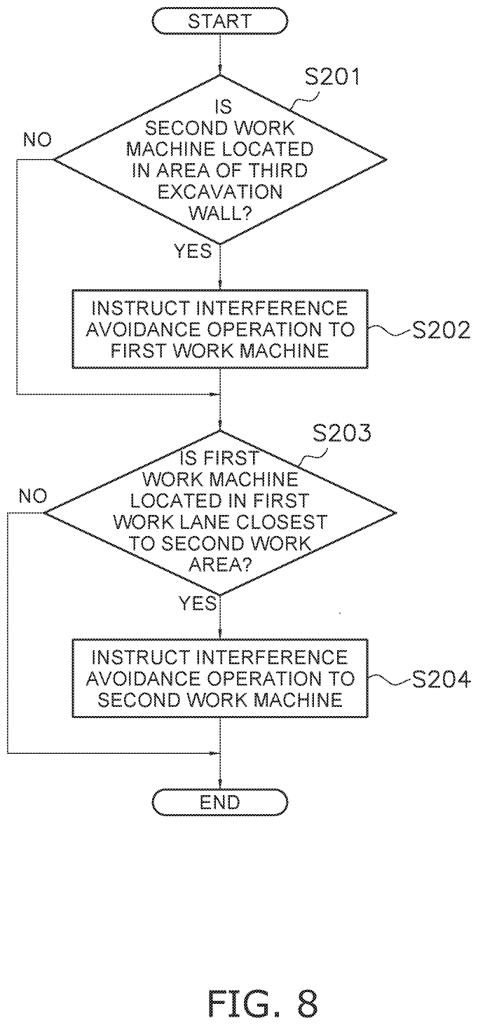

FIG. 8 is a flowchart showing a process of controlling for the interference avoidance operation. As illustrated in FIG. 8, in step S201, the remote controller 2 determines whether at least a part of the second work machine 1b is located in the area 65 of the third excavation wall. When at least a part of the second work machine 1b is located in the area 65 of the third excavation wall, the process proceeds to step S202.

In step S202, the remote controller 2 instructs the first work machine 1a to perform the interference avoidance operation. For example, the remote controller 2 determines the first work lane 53 closest to the second work area 50B and the area 62 of the first excavation wall adjacent to the first work lane 53 as no-entry area C1 for the first work machine 1a. Then, the remote controller 2 makes the first work machine 1a stand by so as not to enter the no-entry area C1.

In step S201, when at least a part of the second work machine 1b is not located in the area 65 of the third excavation wall, the process proceeds to step S203.

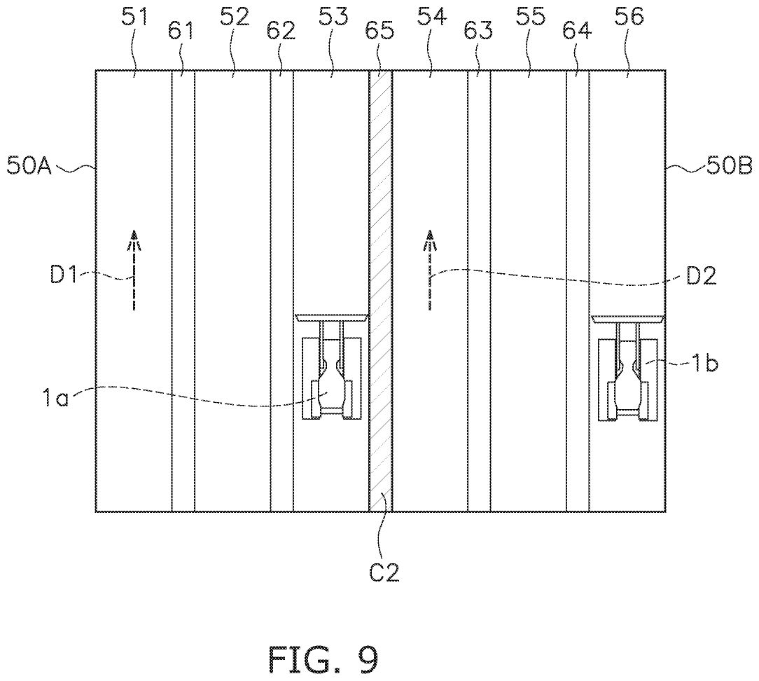

In step S203, the remote controller 2 determines whether the first work machine 1a is located in the first work lane 53 closest to the second work area 50B. As illustrated in FIG. 9, when the first work machine 1a is located in the first work lane 53 closest to the second work area 50B, the process proceeds to step S204.

In step S204, the remote controller 2 instructs the second work machine 1b to perform the interference avoidance operation. For example, the remote controller 2 determines the area 65 of the third excavation wall as the no-entry area C2 for the second work machine 1b. Then, the remote controller 2 makes the second work machine 1b stand by so as not to enter the no-entry area C2.

In the control system 100 for the work machines according to the present embodiment described above, when the second work machine 1b is located in the area 65 of the third excavation wall, the first work machine 1a is controlled to perform the interference avoidance operation. When the first work machine 1a is located in the first work lane 53 closest to the second work area 50B before the second work machine 1b enters the area 65 of the third excavation wall, the second work machine 1b is controlled to perform the interference avoidance operation. As a result, it is possible to prevent a plurality of work machines 1a and 1b from interfering with each other during the automatic operation.

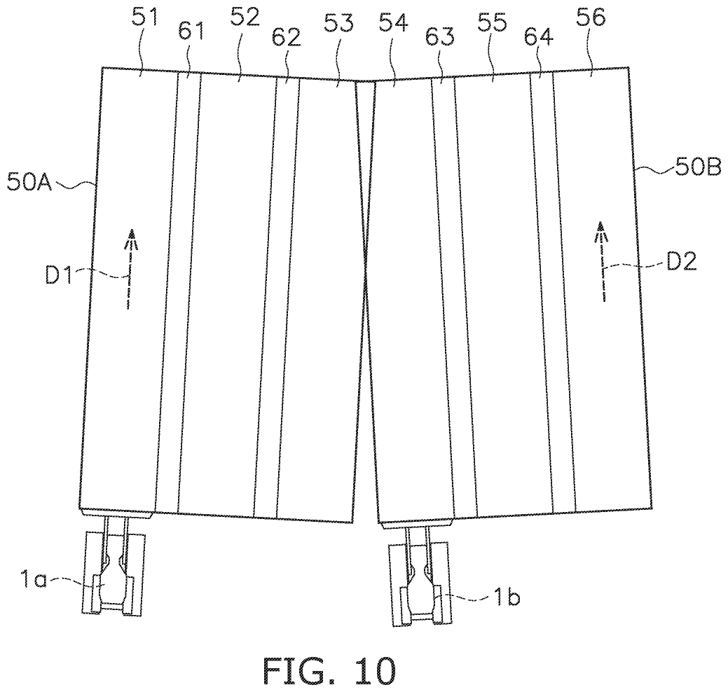

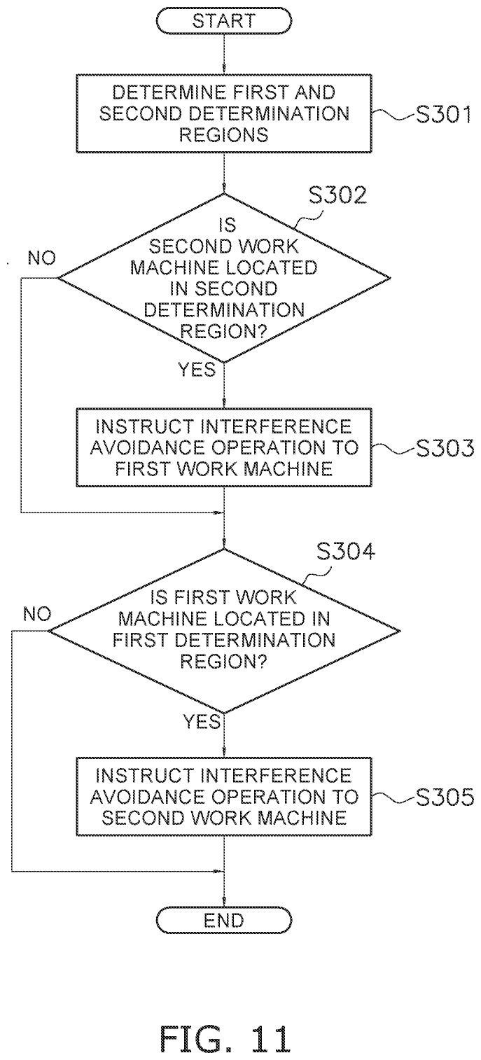

FIG. 10 is a top view of the work site showing an example of the work areas 50A and 50B according to a second embodiment. In the example illustrated in FIG. 10, the first working direction D1 and the second working direction D2 are different from each other. A part of the first work lane 53 closest to the second work area 50B and a part of the second work lane 54 closest to the first work area 50A overlap each other. The first work lane 53 closest to the second work area 50B intersects the second work lane 54 closest to the first work area 50A. FIG. 11 is a flowchart showing the processing of the interference avoidance operation when the first work lane 53 and the second work lane 54 overlap each other.

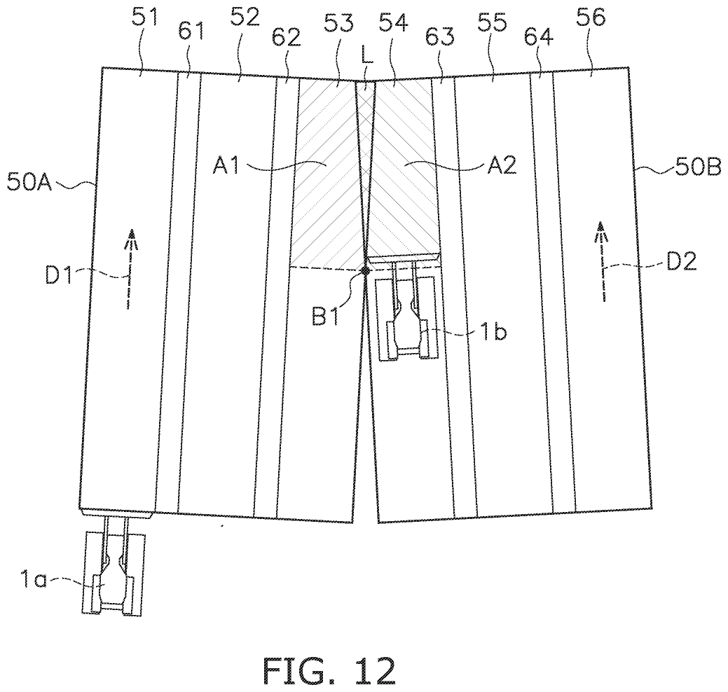

As illustrated in FIG. 11, in step 301, the remote controller 2 determines a first determination region A1 and a second determination region A2. As illustrated in FIG. 12, the first determination region A1 includes an area in the first work lane 53 forward of the overlapping position B1 between the first work lane 53 and the second work lane 54. The first determination region A1 includes at least a part of the first work lane 53 including an overlapping part L with the second work lane 54. The overlapping part L is located laterally with respect to a part of the first work lane 53 that does not overlap with the second work lane 54. The second determination region A2 includes an area in the second work lane 54 forward of the overlapping position B1 between the first work lane 53 and the second work lane 54. The second determination region A2 includes at least a part of the second work lane 54 including the overlapping part L with the first work lane 53. The overlapping part L is located laterally with respect to a part of the second work lane 54 that does not overlap with the first work lane 53.

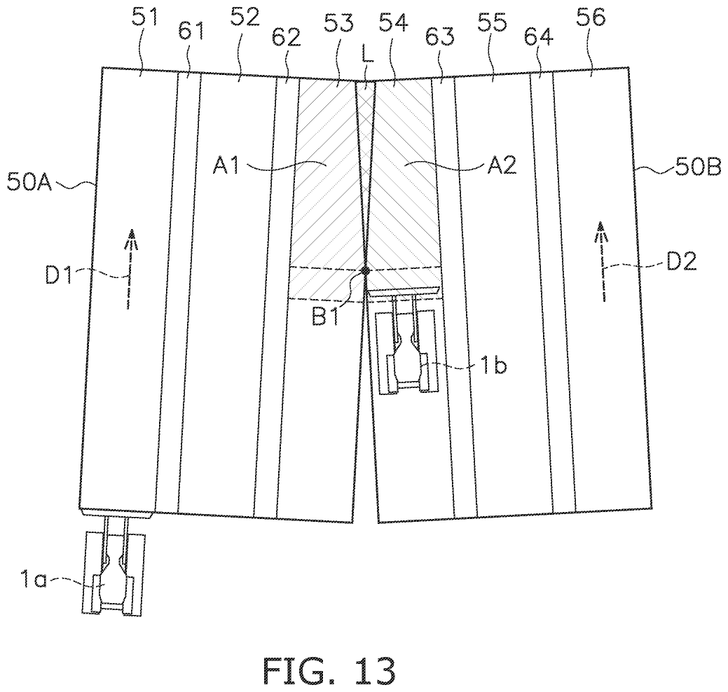

As illustrated in FIG. 13, the remote controller 2 may determine a region forward of a position retracted a predetermined distance from the overlapping position B1 in the first work lane 53 as the first determination region A1. The remote controller 2 may determine a region forward of a position retreated a predetermined distance from the overlapping position B1 in the second work lane 54 as the second determination region A2.

In step S302, the remote controller 2 determines whether the second work machine 1b is located in the second determination region A2. When the second work machine 1b is located in the second determination region A2, the process proceeds to step S303.

In step S303, the remote controller 2 instructs the first work machine 1a to perform the interference avoidance operation. For example, the remote controller 2 makes the first work machine 1a stand by so that the first work machine 1a does not enter the first determination region A1.

In step S302, when the second work machine 1b is not located in the second determination region A2, the process proceeds to step S304. In step S304, the remote controller 2 determines whether the first work machine 1a is located in the first determination region A1. When the first work machine 1a is located in the first determination region A1, the process proceeds to step S305. In step S305, the remote controller 2 instructs the second work machine 1b to perform the interference avoidance operation. For example, the remote controller 2 makes the second work machine 1b stand by so that the second work machine 1b does not enter the second determination region A2.

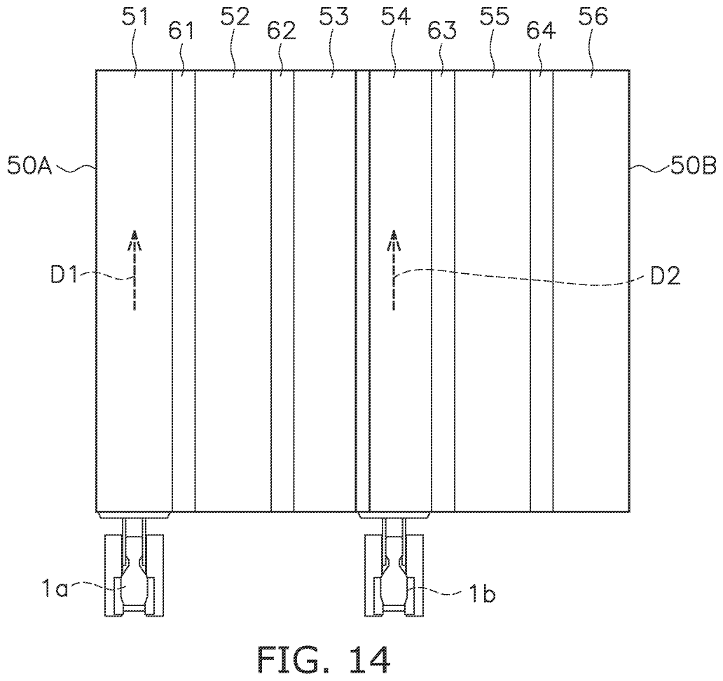

FIG. 14 is a top view of a work site showing an example of work areas 50A and 50B according to a third embodiment. In the example illustrated in FIG. 14, the first working direction D1 and the second working direction D2 are the same. A part of the first work lane 53 closest to the second work area 50B and a part of the second work lane 54 closest to the first work area 50A overlap each other.

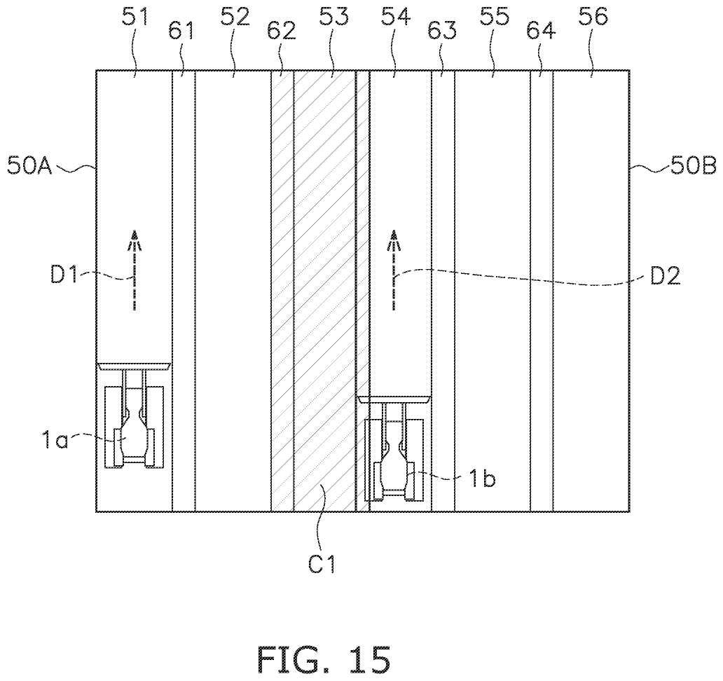

As illustrated in FIG. 15, when at least a part of the second work machine 1b is located in the first work lane 53, the remote controller 2 determines the first work lane 53 and the area 62 of the first excavation wall adjacent to the first work lane 53 as the no-entry area C1. The remote controller 2 controls the first work machine 1a so as not to enter the no-entry area C1.

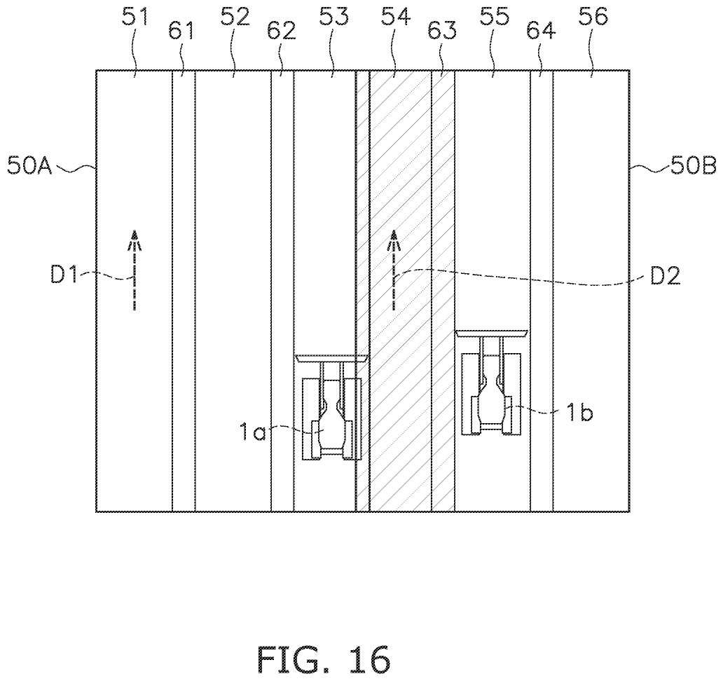

As illustrated in FIG. 16, when at least a part of the first work machine 1a is located in the second work lane 54, the remote controller 2 determines the second work lane 54 and the area 63 of the second excavation wall adjacent to the second work lane 54 as the no-entry area C2. The remote controller 2 controls the second work machine 1b so as not to enter the no-entry area C2.

Although one embodiment has been described above, the present invention is not limited to the above embodiment, and various modifications can be made without departing from the gist of the invention.

The work machines 1a and 1b are not limited to bulldozers, and may be other vehicles, such as wheel loaders and motor graders. The work machines 1a and 1b may be vehicles driven by an electric motor.

The remote controller may have a plurality of controllers that are separate from each other. The processing by the remote controller may be distributed to a plurality of controllers and executed by the plurality of controllers. The machine controller may have a plurality of controllers that are separate from each other. The processing by the machine controller may be distributed to a plurality of controllers and executed by the plurality of controllers. The above-mentioned processing may be distributed to a plurality of processors and executed by the plurality of processors.

The processing for automatic operation and the processing for interference avoidance operation are not limited to those of the above-described embodiments, and may be changed, omitted, or added. The execution order of the process for the automatic operation and the process for the interference avoidance operation is not limited to that of the above-described embodiments, and may be changed. Part of the processing by the machine controller may be performed by the remote controller. Part of the processing by the remote controller may be performed by the machine controller.

The work machines 1a and 1b may independently perform the interference avoidance operation. For example, the processes of steps S201 and S202 may be executed by the machine controller 26a of the first work machine 1a. The processes of steps S203 and S204 may be executed by the machine controller of the second work machine 1b. The processes of steps S302 and S303 may be executed by the machine controller 26a of the first work machine 1a. The processes of steps S304 and S305 may be executed by the machine controller of the second work machine 1b. The machine controller 26a of the first work machine 1a may directly receive the second position data from the machine controller of the second work machine 1b. The machine controller of the second work machine 1b may directly receive the first position data from the machine controller of the first work machine 1a.

The control of the work machines 1a and 1b may be fully automatic or semi-automatic. For example, the input device 3 may include an operation member, such as an operation lever, a pedal, or a switch for operating the work machines 1a and 1b. The remote controller 2 may control the travel of the work machines 1a and 1b, such as forward movement, reverse movement, and turning according to the operation of the input device 3. The remote controller 2 may control operations such as ascending and descending of the work implement 13 according to the operation of the input device 3.

The interference avoidance operation is not limited to making the work machine stand by, and may be another operation. For example, the interference avoidance operation may be to slow down the work machines. The no-entry area does not have to include the area of the excavation wall. In each work area, the area of the excavation wall may be omitted.

According to the present disclosure, it is possible to prevent a plurality of work machines from interfering with each other during automatic operation.

1. A system comprising:
a first work machine;
a second work machine; and
one or more processors that control the first work machine and the second work machine, the one or more processors being configured to
allocate to the first work machine a first work area including a plurality of first work lanes extending in a predetermined first working direction and arranged in a direction intersecting the first working direction,
acquire first position data indicative of a position of the first work machine,
control the first work machine to work according to the first work lane,
allocate to the second work machine a second work area including a plurality of second work lanes extending in a predetermined second working direction and arranged in a direction intersecting the second working direction,
acquire second position data indicative of a position of the second work machine,
control the second work machine to work according to the second work lane,
determine whether at least a part of the second work machine is located in the first work area, and
control the first work machine to perform an interference avoidance operation with respect to the second work machine when at least a part of the second work machine is located in the first work area.

2. The system according to claim 1, wherein
when an area of an excavation wall located between the first work area and the second work area is allocated to the second work machine and at least a part of the second work machine is located in the area of the excavation wall, the one or more processors are configured to control the first work machine to perform the interference avoidance operation with respect to the second work machine.

3. The system according to claim 2, wherein
when at least a part of the second work machine is located in the area of the excavation wall, the one or more processors are configured to determine the first work lane closest to the second work area as a no-entry area for the first work machine.

4. The system according to claim 3, wherein
the one or more processors are configured to control the first work machine to stand by so as not to enter the no-entry area.

5. The system according to claim 1, wherein
when an area of an excavation wall located between the first work area and the second work area is allocated to the second work machine and the first work machine is located in the first work lane closest to the second work area, the one or more processors are configured to control the second work machine so as not to enter the area of the excavation wall.

6. The system according to claim 1, wherein
when a part of the first work lane closest to the second work area and a part of the second work lane closest to the first work area overlap each other, the one or more processors are configured to
determine a first determination region including a first area in the first work lane forward of an overlapping position of the first work lane and the second work lane,
determine a second determination region including a second area in the second work lane forward of the overlapping position,
control the second work machine so as not to enter the second determination region when the first work machine is located in the first determination region, and
control the first work machine so as not to enter the first determination region when the second work machine is located in the second determination region.

7. The system according to claim 6, wherein
the one or more processors are configured to determine a region forward of a position spaced rearward a predetermined distance from the overlapping position in the first work lane as the first determination region.

8. The system according to claim 6, wherein
the one or more processors are configured to determine a region forward of a position spaced rearward a predetermined distance from the overlapping position in the second work lane as the second determination region.

9. A method performed by one or more processors for controlling a plurality of work machines including a first work machine and a second work machine, the method comprising:
allocating to the first work machine a first work area including a plurality of first work lanes extending in a predetermined first working direction and arranged in a direction intersecting the first working direction;
acquiring first position data indicative of a position of the first work machine;
controlling the first work machine to work according to the first work lane;
allocating to the second work machine a second work area including a plurality of second work lanes extending in a predetermined second working direction and arranged in a direction intersecting the second working direction;
acquiring second position data indicative of a position of the second work machine;
controlling the second work machine to work according to the second work lane;
determining whether at least a part of the second work machine is located in the first work area; and
controlling the first work machine to perform an interference avoidance operation with respect to the second work machine when at least a part of the second work machine is located in the first work area.

10. The method according to claim 9, further comprising:
when an area of an excavation wall located between the first work area and the second work area is allocated to the second work machine and at least a part of the second work machine is located in the area of the excavation wall, controlling the first work machine to perform the interference avoidance operation with respect to the second work machine.

11. The method according to claim 10, further comprising:
determining the first work lane closest to the second work area as a no-entry area for the first work machine when at least a part of the second work machine is located in the area of the excavation wall.

12. The method according to claim 11, further comprising:
controlling the first work machine to stand by so as not to enter the no-entry area.

13. The method according to claim 9, further comprising:
when an area of an excavation wall located between the first work area and the second work area is allocated to the second work machine and the first work machine is located in the first work lane closest to the second work area, controlling the second work machine so as not to enter the area of the excavation wall.

14. The method according to claim 9, further comprising:
when a part of the first work lane closest to the second work area and a part of the second work lane closest to the first work area overlap each other, determining a first determination region including a first area in the first work lane forward of an overlapping position of the first work lane and the second work lane;
determining a second determination region including a second area in the second work lane forward of the overlapping position;
controlling the second work machine so as not to enter the second determination region when the first work machine is located in the first determination region; and
controlling the first work machine so as not to enter the first determination region when the second work machine is located in the second determination region.

15. The method according to claim 14, further comprising:
determining a region forward of a position spaced rearward a predetermined distance from the overlapping position in the first work lane as the first determination region.

16. The method according to claim 14, further comprising:
determining a region forward of a position spaced rearward a predetermined distance from the overlapping position in the second work lane as the second determination region.

17. A system comprising:
a first work machine;
a second work machine; and
one or more processors that control the first work machine and the second work machine, the one or more processors being configured to
allocate to the first work machine a first work lane extending in a predetermined first working direction,
acquire first position data indicative of a position of the first work machine, control the first work machine to work according to the first work lane,
allocate to the second work machine a second work lane extending in a predetermined second working direction,
acquire second position data indicative of a position of the second work machine,
control the second work machine to work according to the second work lane,
determine whether at least a part of the second work machine is located in the first work lane, and
control the first work machine to perform an interference avoidance operation with respect to the second work machine when at least a part of the second work machine is located in the first work lane.

18. The system according to claim 17, wherein
the first work lane extends linearly in the predetermined first working direction, and
the second work lane extends linearly in the predetermined second working direction and intersects with the first work lane.

19. The system according to claim 17, wherein
the first work lane and the second work lane include an overlapping part in which the first work lane and the second work lane overlap each other, and
the one or more processors are configured to
determine at least a part of the first work lane including the overlapping part as a first determination region,
determine at least a part of the second work lane including the overlapping part as the second determination region, and
control the first work machine so as not to enter the first determination region when at least a part of the second work machine is located in the second determination region.

20. The system according to claim 17, wherein
the first work lane extends linearly in the predetermined first working direction,
the second work lane extends linearly in the predetermined second working direction and intersects with the first work lane,
the first work lane and the second work lane include an overlapping part in which the first work lane and the second work lane overlap each other, and
the one or more processors are configured to
determine at least a part of the first work lane including the overlapping part as a first determination region,
determine at least a part of the second work lane including the overlapping part as a second determination region, and
control the first work machine so as not to enter the first determination region when at least a part of the second work machine is located in the second determination region.
